(19) United States
(12) Patent Application Publication
(10) Pub. No.: US 2026/0194689 A1
(43) Pub. Date: Jul. 9, 2026

(54) TROPICAL NIGHT DETECTION DEVICE AND TROPICAL NIGHT DETERMINATION METHOD USING THE SAME

(71) Applicant: NATIONAL INSTITUTE OF METEOROLOGICAL SCIENCES, Seogwipo-si (KR)

(72) Inventors: Yoo Jun KIM, Gangneung-si (KR); Byung Hwan LIM, Gangneung-si (KR)

(21) Appl. No.: 19/373,761

(22) Filed: Oct. 30, 2025

(30) Foreign Application Priority Data
Jan. 7, 2025 (KR) 10-2025-0002069

(51) Int. Cl. G01W 1/06; G01W 1/10

(52) U.S. Cl. CPC G01W 1/06; G01W 1/10

(57) ABSTRACT

Provided is a tropical night determination apparatus including a tropical night detection device and an external server. More specifically, the tropical night determination apparatus is movable and identifies tropical night information in real time in a specific location. A tropical night detection method provided herein uses the tropical night determination apparatus.

### CROSS-REFERENCE TO RELATED APPLICATIONS

This application claims the priority of Korean Patent Application No. 10-2025-0002069 filed on Jan. 7, 2025, in the Korean Intellectual Property Office, the disclosure of which is incorporated herein by reference.

### BACKGROUND

### Field

The present disclosure relates to a tropical night detection device and a tropical night determination method using the same.

### Description of the Related Art

In Korea, variability of urban summer temperatures has been increasing due to the impact of climate changes, but the ability to respond to the summer heat waves caused by the urban temperature rise is still insufficient. In order to strengthen the heat wave responding ability, impact forecasting measures for sectors including health, industry, and livestock are requested.

In the meantime, the mutual atmospheric physical processes between the atmosphere and the ground surface occur under the control of the synoptic meteorological model and the local structural environmental characteristic of the ground surface. On the surface boundary layer below the atmospheric boundary layer, in order to calculate a predictive value for one meteorological variable, complex interactions of other variables need to be reflected and a degree of influence weighted on the meteorological factors, such as an air temperature and a humidity for every city characteristic, meteorological variable, and temporal and spatial scale should be calculated.

As described above, there is a growing need for a method for real-time operation and prediction of localized, detailed meteorological prediction information near the ground surface or for utilizing the information in impact-based forecasting of summer heat waves and tropical nights.

A background art of the present disclosure is disclosed in Korean Unexamined Patent Application Publication No. 10-2020-0111331.

### SUMMARY

The present disclosure is provided to solve the above-described problems of the related art and an object thereof is to provide a tropical night detection device which is movable and identifies tropical night information in real time in a specific location and a tropical night detection method using the same.

However, objects to be achieved by various exemplary embodiments of the present disclosure are not limited to the technical objects as described above and other technical objects may be present.

As a technical means to achieve the above-described technical object, according to a first aspect of the present disclosure, a tropical night determination apparatus including a tropical night detection device and an external server is provided. The tropical night detection device includes: a road surface condition information acquisition unit which acquires road surface condition information; a surrounding meteorological environment information acquisition unit which acquires information about a meteorological environment around the tropical night detection device; a location information unit which acquires location information of the tropical night detection device; a communication unit which transmits and receives data between the tropical night detection device and the external server; and a controller which controls an operation of the tropical night detection device. The external server includes a local processing server including a tropical night determination unit which analyzes data received from the tropical night detection device to determine whether the surrounding area is experiencing a tropical night and the road surface condition information includes a temperature of a road surface and humidity information of a road surface.

According to an implementation example of the present disclosure, the surrounding meteorological environment information acquisition unit may acquire information including at least one of information about an air temperature, a humidity, and whether there is rainfall of the surrounding environment where the tropical night detection device is located, but is not limited thereto.

According to an implementation example of the present disclosure, the external server may further include Meteorological Administration model prediction materials and the local processing server may further include Meteorological Administration model materials, GIS database, and a wind determination algorithm, but they are not limited thereto.

According to an implementation example of the present disclosure, the external server may calculate an apparent temperature through information transmitted from the tropical night detection device and transmit the tropical night determination information for the surrounding area to the tropical night detection device, but they are not limited thereto.

According to an implementation example, the apparent temperature may be calculated by the following Equation 1, but is not limited thereto.

$$Apparent Temperature = - 0.2442 + 0.55399 T w + 0.45535 Ta - 0.0 \; 022 {Tw}^{2} + 0.0 \; 0278 TwTa + 3. \qquad [ Equation 1 ]$$

(in Equation 1, Tw is a wet bulb temperature and Ta is an air temperature).

According to an implementation example of the present disclosure, the tropical night detection device may further include a display unit which outputs the apparent temperature and tropical night determination information, but is not limited thereto.

According to an implementation example, the tropical night determination unit may determine whether the surrounding area is experiencing a tropical night in consideration of an air temperature, a humidity, a strength and a duration of wind, an apparent temperature and the road surface condition information of a surrounding area of the tropical night detection device, but is not limited thereto.

According to an implementation example of the present disclosure, the model prediction materials of the Korea Meteorological Administration may include prediction information of wind from a predetermined altitude, but are not limited thereto.

According to an implementation example, the predetermined altitude may be 10 m to 20 m, but is not limited thereto.

According to an implementation example of the present disclosure, the tropical night detection device may further include a water spraying unit which sprays water on a road, but is not limited thereto.

According to an implementation example of the present disclosure, the tropical night detection device may be mounted in a vehicle, but is not limited thereto.

Further, according to a second aspect of the present disclosure, a tropical night determination method using a tropical night determination apparatus according to the first aspect includes: a step of collecting location information of a surrounding area, air temperature (Ta) and humidity (RH) information of daytime or nighttime, road surface condition information including a road surface temperature and a road surface condition, and a strength and a duration of wind; a step of calculating an apparent temperature by means of the air temperature and humidity information; a first identification step of identifying whether the apparent temperature is a first temperature or higher or a road surface temperature is a second temperature or higher and a road surface condition is dry; a second identification step of identifying whether the strength of the wind is a first wind speed or higher and the duration is a first time or longer when the first identification step is satisfied; a third identification step of identifying whether the apparent temperature is a third temperature or higher, the strength of the wind is a second wind speed or higher and the duration is a second time or longer when the second identification step is satisfied; and a step of overlapping a heat map based on the location information when the third identification step is satisfied.

According to an implementation example, the first temperature, the second temperature, and the third temperature may be independently 20° C. to 60° C., but are not limited thereto.

According to an implementation example, the first wind speed and the second wind speed may be independently 2 m/s to 4 m/s, but are not limited thereto.

According to an implementation example of the present disclosure, the first time and the second time may be two hours to four hours, but are not limited thereto.

According to an implementation example, the wind may include a wind blowing from 10 m to 20 m, but is not limited thereto.

According to an implementation example of the present disclosure, the step of overlapping the heat map may further include a step of analyzing and correcting a surrounding environment condition based on GIS database information, but is not limited thereto.

The above-described solving means are merely illustrative but should not be construed as limiting the present disclosure. In addition to the above-described embodiments, additional embodiments may be further provided in the drawings and the detailed description of the present disclosure.

According to the above-described solving means of the present disclosure, a tropical night determination apparatus includes a tropical night detection device which is mounted in a vehicle to collect information required to determine tropical nights so that meteorological information in vulnerable areas may be accurately identified.

Further, tropical night risk information may be corrected using GIS database information which analyzes surrounding environmental conditions (information of bridges, mountainous areas, and areas with vulnerable populations) and the tropical night information may be displayed on an electronic board to reduce and relieve damages caused by the tropical nights and the ground surface may be cooled down by water spraying.

Further, not only temperature and humidity conditions, but also wind strength and duration, an apparent temperature, and road surface observation information are additionally considered to output tropical night (heat wave during the daytime) determination information.

However, the effect which can be achieved by the present disclosure is not limited to the above-described effects, there may be other effects.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram of a tropical night determination apparatus according to one implementation example of the present disclosure;

FIG. 2 is a diagram of a tropical night determination apparatus according to one implementation example of the present disclosure;

FIG. 3 is a table of an apparent temperature according to an air temperature and a humidity;

FIG. 4 is a diagram of a tropical night determination apparatus according to one implementation example of the present disclosure;

FIG. 5 is a flowchart of a tropical night determination method according to one implementation example of the present disclosure;

FIG. 6 is a flowchart of a tropical night determination method according to one implementation example of the present disclosure;

FIG. 7 is a diagram of a tropical night determination apparatus according to an exemplary embodiment of the present disclosure; and

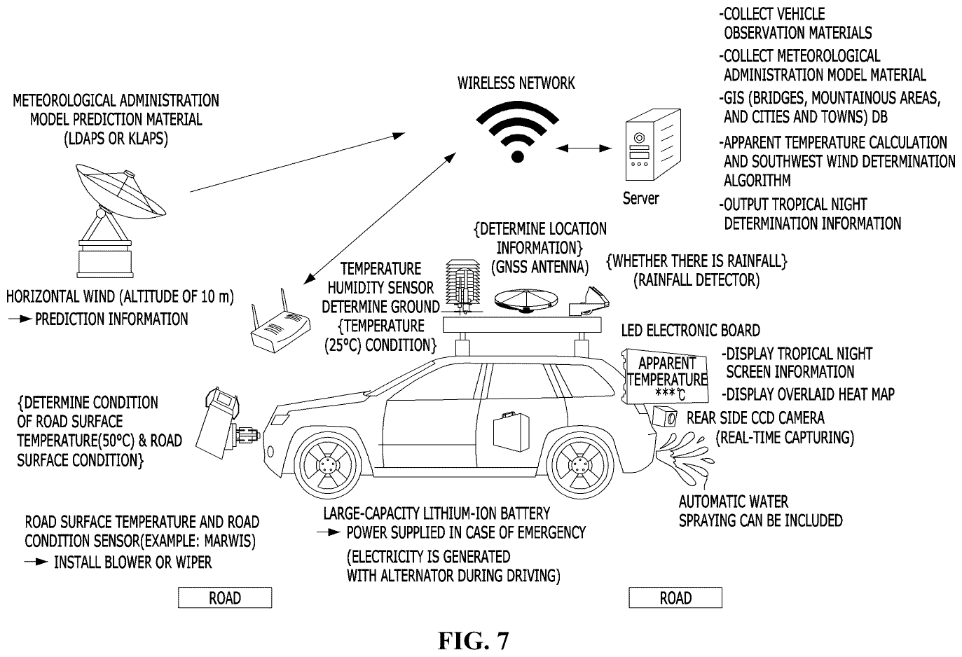

FIG. 8 is an image in which a heat map is overlaid on a map, according to an exemplary embodiment of the present disclosure.

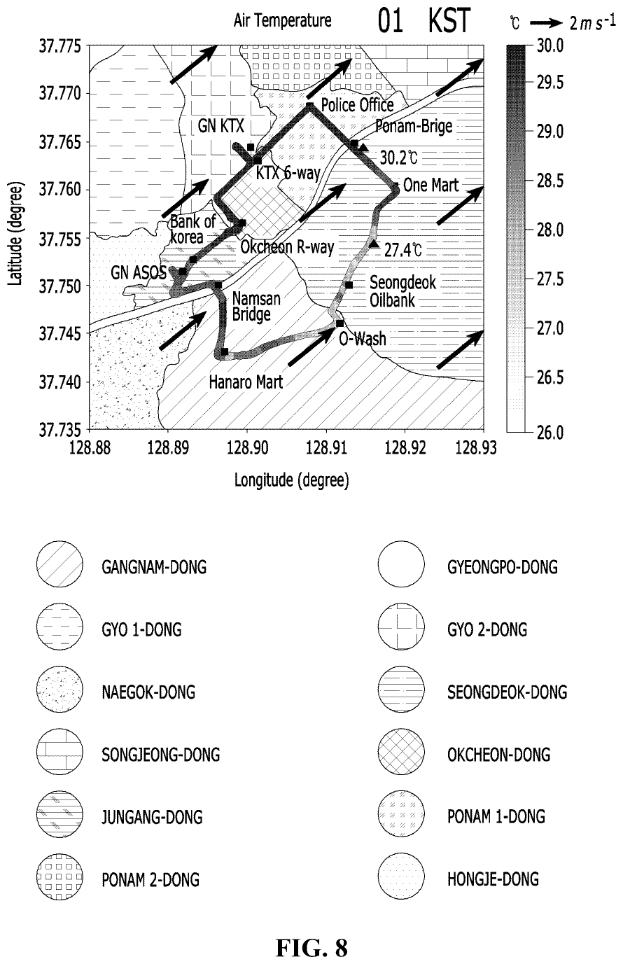

### DETAILED DESCRIPTION OF THE EMBODIMENT

Hereinafter, the present disclosure will be described more fully hereinafter with reference to the accompanying drawings, in which exemplary embodiments of the present disclosure are shown.

However, the present disclosure can be realized in various different forms, and is not limited to the embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” to the other element through a third element.

Through the specification of the present disclosure, when one member is located “on”, “above”, “on an upper portion”, “below”, “under”, and “on a lower portion” of the other member, the member may be adjacent to the other member or a third member may be disposed between the above two members.

In the specification, unless explicitly described to the contrary, the word “comprise” and variations such as “comprises” or “comprising”, will be understood to imply the inclusion of stated elements but not the exclusion of any other elements.

Hereinafter, a tropical night detection device according to an implementation example and an exemplary embodiment of the present disclosure and a tropical night detection method using the same will be described. Specifically, the tropical night detection device is included in the tropical night determination apparatus and may determine whether an area where the tropical night detection device is located is experiencing a tropical night by means of an external server of the tropical night determination apparatus.

As a technical means to achieve the above-described technical object, according to a first aspect of the present disclosure, a tropical night determination apparatus including a tropical night detection device and an external server is provided. The tropical night detection device includes: a road surface condition information acquisition unit which acquires road surface condition information; a surrounding meteorological environment information acquisition unit which acquires information about a meteorological environment around the tropical night detection device; a location information unit which acquires location information of the tropical night detection device; a communication unit which transmits and receives data between the tropical night detection device and the external server; and a controller which controls an operation of the tropical night detection device. The external server includes a local processing server including a tropical night determination unit which analyzes data received from the tropical night detection device to determine whether the surrounding area is experiencing tropical night. The road surface condition information includes a temperature of a road surface and humidity information of the road surface.

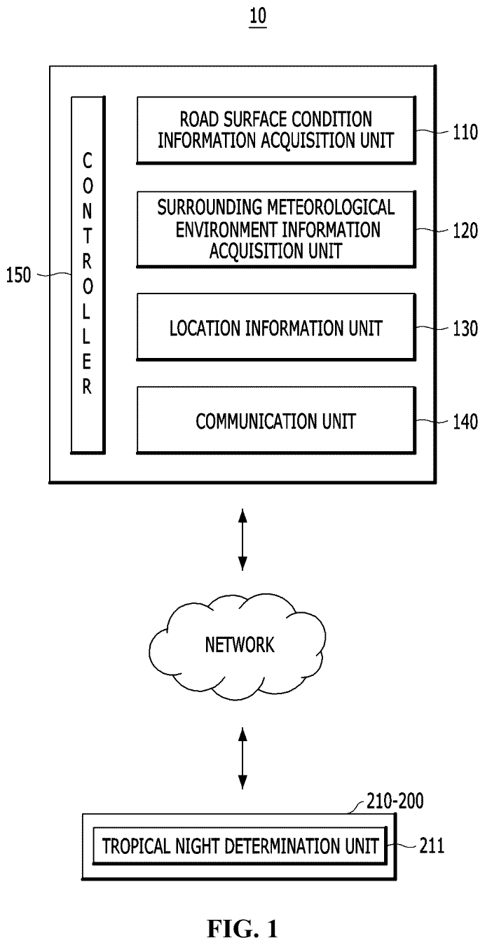

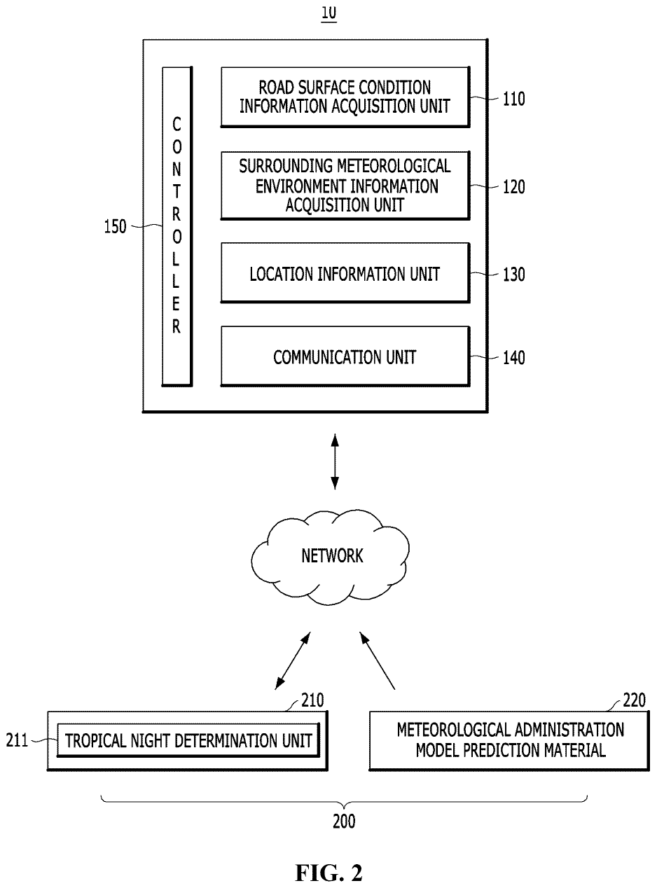

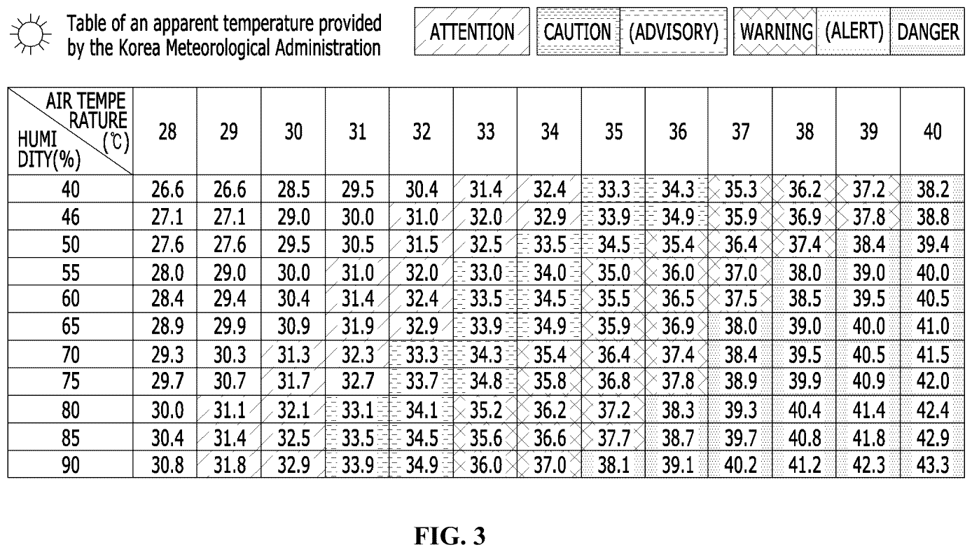

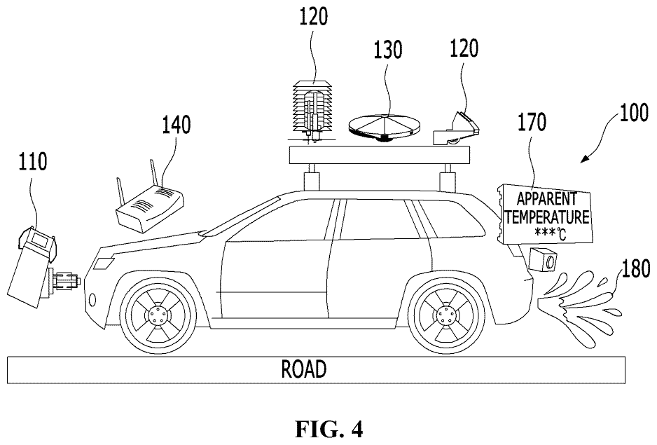

FIGS. 1, 2, and 4 are diagrams of a tropical night determination apparatus according to one implementation example of the present disclosure and FIG. 3 is a table of an apparent temperature according to an air temperature and a humidity. Specifically, FIG. 3 is a table obtained by calculating an apparent temperature with a temperature and a humidity of a daytime environment (for example, from 09:00 to 18:00) and FIG. 4 is a diagram of a tropical night detection device.

The road surface condition information acquisition unit according to the present disclosure acquires a temperature of a road surface and humidity information of the road surface. Specifically, the humidity information of the road surface is to determine whether the road surface is dry or wet.

The road surface condition information acquisition unit may include MARWIS which is a road surface sensor. As it will be described below, if the road surface temperature and the road surface humanity information satisfy a predetermined condition, a place where the tropical night determination apparatus is located may be determined as a tropical night.

According to one implementation example of the present disclosure, the surrounding meteorological environment information acquisition unit may acquire information including at least one of information about an air temperature, a humidity, and whether there is rainfall of the surrounding environment where the tropical night detection device is located, but is not limited thereto. That is, the surrounding meteorological environment information acquisition unit may include a temperature-humidity sensor and a rainfall sensor and the temperature and humidity sensor may measure a temperature and a humidity of surrounding atmosphere.

The surrounding meteorological environment information acquisition unit collects real-time meteorological information of the surrounding environment where the tropical night detection device is located. Specifically, a temperature, a humidity, and rainfall information measured in a location of the tropical night detection device may be acquired, rather than a weather forecast and it may be determined whether tropical night occurs in the place where the tropical night detection device is located based on the above-mentioned information.

The location information acquisition unit according to the present disclosure includes a position sensor, such as a GNSS antenna and may determine a specific location of the tropical night detection device. At this time, not only through the position sensor, but also through a wireless network included in the communication unit, a position error may be minimized.

According to an implementation example of the present disclosure, the external server may further include collected Meteorological Administration model prediction materials and the local processing server may further include Meteorological Administration model materials, GIS database, and a wind determination algorithm, but the present disclosure is not limited thereto.

Specifically, the external server includes a local processing server configured to output Meteorological Administration model prediction materials including a Local Data Assimilation and Prediction system (LDAPS) or Korea Local Analysis and Prediction System (KLAPS), materials collected from the tropical night determination unit and the tropical night detection device, Meteorological Administration model materials, GIS database, an apparent temperature calculation and wind determination algorithm, and tropical night determination information.

As it will be described below, a direction of the wind which is analyzed by the external server may be a south wind, but is not limited thereto. Desirably, the direction of the wind may include all south wind series (south wind, southeast wind, and southwest wind) and a wind direction of the south wind may range from 112.5° to 247.5°.

According to an implementation example of the present disclosure, the Meteorological Administration model prediction materials may include prediction information of a wind blowing from a predetermined altitude, but are not limited thereto.

According to an implementation example, the predetermined altitude may be 10 m to 20 m, but is not limited thereto.

That is, through the Meteorological Administration model prediction materials, prediction information about a strength and a duration of the south wind blowing horizontally at an altitude of 10 m may be acquired.

The communication unit according to the present disclosure transmits and receives data between the tropical night detection device and the external server. For example, the LDAPS or KLAPS of the Meteorological Administration model prediction materials is transmitted to the local processing server through a wireless network and the communication unit of the tropical night detection device transmits road surface condition information, surrounding meteorological environment information, and location information to the local processing server through the wireless network. At this time, the Meteorological Administration model materials, GIS database, and the apparent temperature calculation and wind determination algorithm included in the local processing server, the LDAPS or KLPAS of the Meteorological Administration model prediction materials, and information transmitted from the tropical night detection device are calculated in the tropical night determination unit to output tropical night determination information. Next, the tropical night determination information is transmitted to the tropical night detection device via the wireless network and the communication unit and is notified to the surroundings through the display unit to be described below.

The local processing server may further include weather observation data.

According to an implementation example of the present disclosure, the external server may calculate an apparent temperature through information transmitted from the tropical night detection device and transmit the tropical night determination information for the surrounding area to the tropical night detection device, but is not limited thereto.

According to an implementation example, the tropical night determination unit may determine whether the tropical night occurs in the surrounding area in consideration of an air temperature, a humidity, a strength and a duration of wind, an apparent temperature, and the road surface condition information of a surrounding area of the tropical night detection device, but is not limited thereto.

According to an implementation example, the apparent temperature may be calculated by the following Equation 1, but is not limited thereto.

$$Apparent Temperature = - 0.2442 + 0.55399 T w + 0.45535 Ta - 0.0 \; 022 {Tw}^{2} + 0.0 \; 0278 TwTa + 3. \qquad [ Equation 1 ]$$

(in Equation 1, Tw is a wet bulb temperature and Ta is an air temperature).

At this time, the wet bulb temperature may be obtained by Estimation Equation of Stull using an air temperature Ta and humidity RH. Specifically, the wet bulb temperature Tw may be calculated by Equation 2.

$$Tw = Ta {tan}^{- 1} [ 0.151977 {( RH + 8.313659 )}^{1 / 2} ] + {tan}^{- 1} ( Ta + RH ) - {tan}^{- 1} ( RH - 1.67633 ) + 0.00391838 {RH}^{3 / 2} {tan}^{- 1} ( 0.023 \; 101 RH ) - 4.686035 \qquad [ Equation 2 ]$$

(in Equation 2, Tw is a wet bulb temperature, Ta is an air temperature (temperature), and RH is a humidity).

The temperature and humidity of the tropical night detection device obtained by the surrounding meteorological environment information acquisition unit of the tropical night detection device are applied to FIG. 3 to calculate an apparent temperature.

At this time, referring to FIG. 3, if the apparent temperature is 31° C. or higher and lower than 33° C., it is classified as “attention”, if the apparent temperature is 33° C. or higher and lower than 35° C., it is classified as caution (or advisory), if the apparent temperature is 35° C. or higher and lower than 38° C., it is classified as warning (alert), and if the apparent temperature is 38° C. or higher, it is classified as danger. Accordingly, in order to prevent the damage caused by the tropical night, there is a need for a device to provide information about the tropical night and for countermeasures against the tropical night.

According to an implementation example of the present disclosure, the tropical night detection device may further include a display unit which outputs the apparent temperature and the tropical night determination information, but is not limited thereto.

According to an implementation example of the present disclosure, the tropical night detection device may further include a water spraying unit which sprays water on a road, but is not limited thereto.

According to an implementation example of the present disclosure, the tropical night detection device may be mounted in a vehicle, but is not limited thereto.

Referring to FIG. 4, the tropical night detection device may be mounted in a vehicle to identify the surrounding temperature and humidity, and whether there is the rainfall, acquire a temperature of the road surface and road surface condition information, and then transmit the information to the external server via the communication unit together with the location information. Next, when the external server determines that the location (that is, the tropical night detection device) of the vehicle is experiencing a tropical night, information about the apparent temperature and whether it is a tropical night is notified through the display unit and at the same time, the temperature of the road surface is lowered by the water spraying unit to reduce the surrounding temperature.

Further, according to a second aspect of the present disclosure, a tropical night determination method using a tropical night determination apparatus according to the first aspect includes: a step of collecting location information of a surrounding area, air temperature (Ta) and humidity (RH) information of daytime or nighttime, road surface condition information including a road surface temperature and a road surface condition, and a strength and a duration of a wind; a step of calculating an apparent temperature by means of the air temperature and humidity information; a first identification step (risk level 1) of identifying whether the apparent temperature is a first temperature or higher, a road surface temperature is a second temperature or higher or a road surface condition is dry; a second identification step (risk level 2) of identifying whether the strength of the wind is a first wind speed or higher and a duration is a first time or longer when the first identification step is satisfied; a third identification step (risk level 3) of identifying whether the apparent temperature is a third temperature or higher, the strength of the wind is a second wind speed or higher and a duration is a second time or longer when the second identification step is satisfied; and a step of overlapping a heat map based on the location information when the third identification step is satisfied.

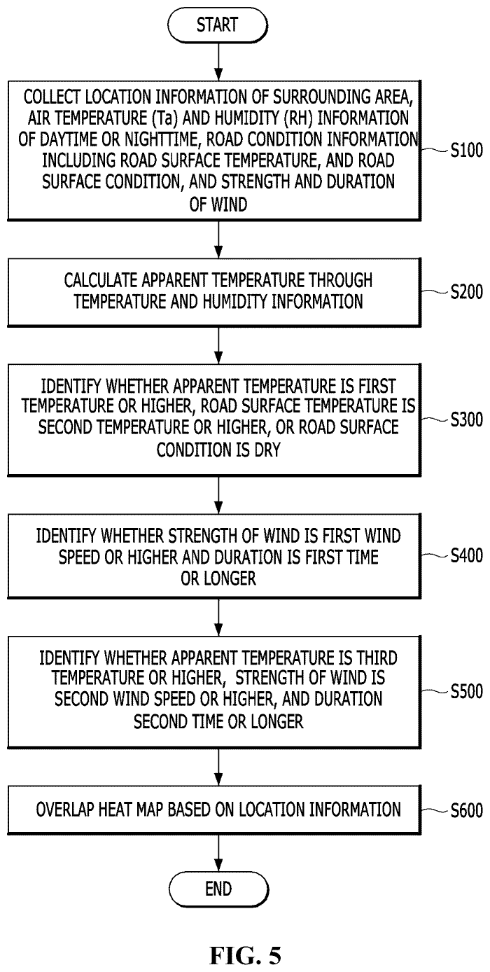

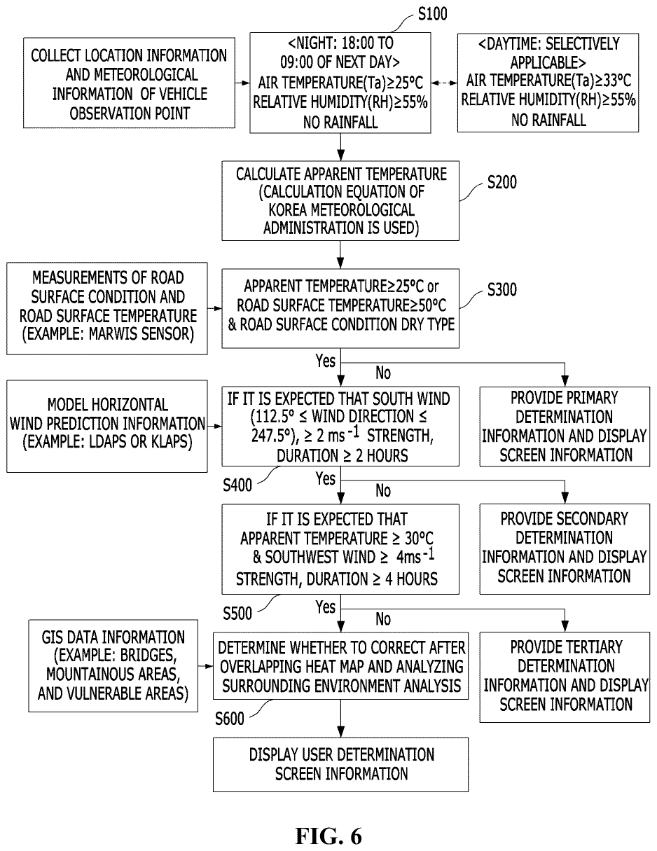

FIGS. 5 and 6 are flowcharts of a tropical night determination method according to one implementation example of the present disclosure. FIG. 6 specifically illustrates FIG. 5.

First, location information of a surrounding area, air temperature (Ta) and humidity (RH) information of daytime or nighttime, road surface condition information including road surface temperature and road surface condition, and a strength and a duration of a wind are collected in step S100.

At this time, the location information of a surrounding area, the air temperature (Ta) and humidity (RH) information of daytime or nighttime, and the road surface condition information may be acquired by the location information unit, the surrounding meteorological environment information acquisition unit, and the road surface condition information acquisition unit of the tropical night detection device. The strength and the duration of the wind may be acquired from the Meteorological Administration model prediction materials, the Meteorological Administration model materials, or meteorological observation materials.

Next, it is identified whether a temperature during the nighttime (from 18:00 to 09:00 of the next day) is 25° C. or higher, a relative humidity is 55% or higher, and no rainfall occurs. At this time, optionally, it is identified whether a temperature during the daytime (from 09:00 to 18:00) is 33° C. or higher, a relative humidity is 55% or higher, and no rainfall occurs and the daytime temperature and humidity may provide heat wave information, rather than the tropical night information.

Next, the wet bulb temperature is calculated by the temperature and the relative humidity and the apparent temperature is calculated by Equation 1 in step S200.

Next, it is identified whether the apparent temperature is a first temperature or higher or a road surface temperature is a second temperature or higher and a road surface condition is dry in step S300 (first identification step).

Next, when the first identification step is satisfied, it is identified whether the strength of the wind is a first wind speed or higher and the duration is a first time or longer in step S400 (second identification step).

Next, when the second identification step is satisfied, it is identified whether the apparent temperature is a third temperature or higher, the strength of the wind is a second wind speed or higher and the duration is a second time or longer in step S500 (third identification step).

As the process proceeds from the first identification step to the third identification step, it means that the risk level of the tropical night increases.

According to an implementation example, the first temperature, the second temperature, and the third temperature may be independently 20° C. to 60° C., but are not limited thereto. At this time, the first temperature and the third temperature refer to apparent temperatures and the second temperature refers to a road surface temperature.

Desirably, the first temperature may be 25° C., the third temperature may be 30° C., and the second temperature may be 50° C.

As described above, FIG. 3 is a table of an apparent temperature provided by the Korea Meteorological Administration, presenting alert criteria based solely on daytime heat wave. The present disclosure is to present alert criteria for the tropical night, that is, nighttime heat wave.

Among the first to third temperatures, the first temperature and the third temperature corresponding to the apparent temperatures may be 25° C. and 30° C., respectively. With regard to this, the tropical night and the super tropical night are determined based on the surrounding temperature, rather than the apparent temperature and the tropical night is determined based on 25° C. and the super tropical night is determined based on 30° C.

The tropical night determination apparatus according to the present disclosure does not detect the environment where the tropical night detection device is located not only with a critical temperature, but identifies whether it exceeds a critical temperature of the tropical night with the temperature (S100 of FIG. 6), and then determines whether it is a tropical night by means of the apparent temperature and the road surface temperature in consideration of the temperature and the humidity (after S300 of FIG. 6).

According to an implementation example, the wind may include a wind blowing from 10 m to 20 m, but is not limited thereto.

According to an implementation example, the first wind speed and the second wind speed may be independently 2 m/s to 4 m/s, but are not limited thereto.

According to an implementation example of the present disclosure, the first time and the second time may be two hours to four hours, but are not limited thereto.

Specifically, referring to FIG. 6, in the first identification step, it is identified whether the apparent temperature is 25° C. or higher or the road surface temperature is 50° C., and the road is dry. At this time, if the apparent temperature is lower than 25° C. and the road surface temperature is lower than 50° C., or the road surface is not dry, the tropical night determination unit provides primary determination information to the tropical night detection device and displays screen information on the display unit of the tropical night detection device.

Next, in the second identification step, it is identified whether it is expected that the wind speed of the south wind (112.5°≤wind direction≤) 247.5° is 2 m/s or higher and the duration of the wind is two hours or longer, and the south wind may include a southwest wind, southeast wind, or a due south wind. At this time, if the wind speed is lower than 2 m/s or the duration is shorter than two hours, the tropical night determination unit provides secondary determination information to the tropical night detection device and displays the screen information on the display unit of the tropical night detection device.

Next, the third identification step is to identify whether the apparent temperature is 30° C. or higher, the wind speed is 4 m/s or higher, and the duration of the wind is four hours or longer. At this time, if the apparent temperature is lower than 30° C. or wind speed is lower than 4 m/s or the duration is shorter than four hours, the tropical night determination unit provides tertiary determination information to the tropical night detection device and displays the screen information on the display unit of the tropical night detection device.

At this time, when the primary determination information to the tertiary determination information are determined, specific values of the apparent temperature, the road surface temperature, the wind speed, the wind duration, and the wind direction may vary as needed.

According to an implementation example of the present disclosure, the step of overlapping the heat map may further include a step of analyzing and correcting a surrounding environment condition based on GIS database information, but is not limited thereto.

Next, when the steps up to the third identification step are satisfied, the heat map is overlaid based on the location information of the tropical night detection device in step S500. However, after performing the first identification step or the second identification step, even though the information, such as apparent temperature, a road surface temperature, a road surface condition, and a strength and a duration of wind do not satisfy the conditions of the first identification step, the second identification step, and the third identification step, the identified data may be overlaid on the heat map.

When the heat map is overlaid, the surrounding environment information according to the GIS database, for example, bridges, mountainous areas, or vulnerable areas is reflected to correct the heat map and the corrected heat map may be overlaid on the map.

The above-description of the present disclosure is illustrative only and it is understood by those skilled in the art that the present disclosure may be easily modified to another specific type without changing the technical spirit of an essential feature of the present disclosure. Thus, it is to be appreciated that embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. A tropical night determination apparatus including a tropical night detection device and an external server,
wherein the tropical night detection device includes:
a road surface condition information acquisition unit which acquires road surface condition information,
a surrounding meteorological environment information acquisition unit which acquires information about a meteorological environment around the tropical night detection device,
a location information unit which acquires location information of the tropical night detection device,
a communication unit which transmits and receives data between the tropical night detection device and the external server; and
a controller which controls an operation of the tropical night detection device,
wherein the external server includes a local processing server including a tropical night determination unit which analyzes data received from the tropical night detection device to determine whether tropical night occurs in the surrounding area and
the road surface condition information includes a temperature of a road surface and humidity information of the road surface,
wherein the tropical night detection device collects location information of a surrounding area, air temperature (Ta) and humidity (RH) information of daytime or nighttime, road surface condition information including a road surface temperature and a road surface condition, and a strength and a duration of a wind, the local processing server calculates an apparent temperature by means of the air temperature and humidity information, performs a first identification of identifying whether the apparent temperature is a first temperature or higher or the road surface temperature is a second temperature or higher and the road surface condition is dry, performs a second identification of identifying whether the strength of the wind is a first wind speed or higher and the duration is a first time or longer when the first identification is satisfied, performs a third identification of identifying whether the apparent temperature is a third temperature or higher, the strength of the wind is a second wind speed or higher and the duration is a second time or longer when the second identification is satisfied, and overlaps a heat map based on the location information when the third identification is satisfied.

2. The tropical night determination apparatus according to claim 1, wherein the surrounding meteorological environment information acquisition unit acquires information including at least one of an air temperature, a humidity, and whether there is rainfall of a surrounding environment where the tropical night detection device is located.

3. The tropical night determination apparatus according to claim 2, wherein the external server further includes Meteorological Administration model prediction materials and the local processing server further includes Meteorological Administration model materials, GIS database, and a wind determination algorithm.

4. The tropical night determination apparatus according to claim 3, wherein the external server calculates an apparent temperature by means of information transmitted from the tropical night detection device and transmits tropical night determination information for the surrounding area to the tropical night detection device.

5. The tropical night determination apparatus according to claim 4, wherein the apparent temperature is calculated by the following Equation 1:
$$Apparent Temperature = - 0.2442 + 0.55399 T w + 0.45535 Ta - 0.0 \; 022 {Tw}^{2} + 0.0 \; 0278 TwTa + 3. \qquad [ Equation 1 ]$$
(in Equation 1, Tw is wet bulb temperature and Ta is air temperature).

6. The tropical night determination apparatus according to claim 4, wherein the tropical night detection device further includes a display unit which outputs the apparent temperature and tropical night determination information.

7. The tropical night determination apparatus according to claim 3, wherein the tropical night determination unit determines whether the tropical night occurs in the surrounding area in consideration of an air temperature, a humidity, a strength and a duration of wind, the apparent temperature, and the road surface condition information of the surrounding area of the tropical night detection device.

8. The tropical night determination apparatus according to claim 3, wherein the Meteorological Administration model prediction materials include prediction information blowing at a predetermined altitude.

9. The tropical night determination apparatus according to claim 8, wherein the predetermined altitude is 10 m to 20 m.

10. The tropical night determination apparatus according to claim 1, wherein the tropical night detection device further includes a water spraying unit which sprays water on the road surface.

11. The tropical night determination apparatus according to claim 1, wherein the tropical night detection device is installed in a vehicle.

12. A tropical night determination method using a tropical night determination apparatus including a tropical night detection device including a road surface condition information acquisition unit which acquires road surface condition information, a surrounding meteorological environment information acquisition unit which acquires information about a meteorological environment around the tropical night detection device, a location information unit which acquires location information of the tropical night detection device, a communication unit which transmits and receives data between the tropical night detection device and an external server, and a controller which controls an operation of the tropical night detection device; and an external server including a local processing server including a tropical night determination unit which analyzes data received from the tropical night detection device to determine whether tropical night occurs in the surrounding area, the method comprising:
a step of collecting location information of a surrounding area, air temperature (Ta) and humidity (RH) information of daytime or nighttime, road surface condition information including a road surface temperature and a road surface condition, and a strength and a duration of a wind,
a step of calculating an apparent temperature by means of the air temperature and humidity information;
a first identification step of identifying whether the apparent temperature is a first temperature or higher or the road surface temperature is a second temperature or higher and the road surface condition is dry;
a second identification step of identifying whether the strength of the wind is a first wind speed or higher and the duration is a first time or longer when the first identification step is satisfied;
a third identification step of identifying whether the apparent temperature is a third temperature or higher, the strength of the wind is a second wind speed or higher and the duration is a second time or longer when the second identification step is satisfied; and
a step of overlapping a heat map based on the location information when the third identification step is satisfied.

13. The tropical night determination method according to claim 12, wherein the first temperature, the second temperature, and the third temperature are independently 20° C., 50° C., and 30° C.

14. The tropical night determination method according to claim 12, wherein the first wind speed and the second wind speed are independently 2 m/s to 4 m/s.

15. The tropical night determination method according to claim 13, wherein the first time and the second time are independently two hours to four hours.

16. The tropical night determination method according to claim 14, wherein the wind includes winds blowing from 10 m to 20 m.

17. The tropical night determination method according to claim 12, wherein the step of overlapping a heat map includes a step of analyzing and correcting a surrounding environment condition based on GIS database information.
